(19) United States
(12) Patent Application Publication
(10) Pub. No.: US 2026/0292605 A1
(43) Pub. Date: Sep. 24, 2026

(54) PRIMARY NODE CHANGE WHILE KEEPING CANDIDATE SECONDARY NODES FOR ENHANCED MOBILITY

(71) Applicant: Apple Inc., Cupertino, CA (US)

(72) Inventors: Shu Guo, Beijing (CN); Naveen Kumar R. Palle Venkata, San Diego, CA (US); Haijing Hu, Los Gatos, CA (US); Ralf Rossbach, Munich (DE); Yuqin Chen, Beijing (CN); Fangli Xu, Beijing (CN); Zhibin Wu, Los Altos, CA (US); Ping-Heng Kuo, London (GB); Alexander Sirotkin, Tel Aviv (IL)

(73) Assignee: Apple Inc., Cupertino, CA (US)

(21) Appl. No.: 19/472,631

(22) PCT Filed: Apr. 5, 2023
(86) PCT No.: PCT/CN2023/086355

§ 371 Date: Oct. 3, 2025

(51) Int. Cl. H04W 36/00; H04W 12/0431; H04W 36/08; H04W 76/20

(52) U.S. Cl. CPC H04W 36/0038; H04W 12/0431; H04W 36/0069; H04W 36/08; H04W 76/20

(57) ABSTRACT

Techniques for a primary node change while keeping secondary node for enhanced mobility are provided. An example method includes a user equipment (UE) receiving, from a current serving cell of a primary node (PN), primary security information that enables the UE to be in dual connectivity mode with the PN and a secondary node (SN). The UE can detect an intra-PN change from the current serving cell to a new serving cell of the PN. The UE can detect that the primary security information remains usable for the UE to remain in the dual connectivity mode with the PN the SN. The UE can remain, while the UE sends data to the new serving cell and the SN, connected with the SN by at least continuing to use the primary security information.

### TECHNICAL FIELD

This application generally relates to wireless communication, and in particular relates to primary node change while keeping candidate secondary nodes for enhanced mobility.

### BACKGROUND

Cellular communications can be defined in various standards to enable communications between a user equipment and a cellular network. For example, long-term evolution (LTE) and Fifth generation (5G) networks are defined by wireless standards that aim to improve upon data transmission speed, reliability, availability, and more.

### BRIEF DESCRIPTION OF THE DRAWINGS

FIG. 1 is an illustration for an intra-primary node (PN) change, according to one or more embodiments.

FIG. 2 is an illustration of an inter-PN change, according to one or more embodiments.

FIG. 3 is a signaling diagram for an intra-PN change, according to one or more embodiments.

FIG. 4 is a signaling diagram for an inter-PN change, according to one or more embodiments.

FIG. 5 is a process flow for an intra-PN change, according to one or more embodiments.

FIG. 6 is a process flow for an inter-PN change, according to one or more embodiments.

FIG. 7 illustrates an example of receive components, in accordance with some embodiments.

FIG. 8 illustrates an example of a user equipment (UE), in accordance with some embodiments.

FIG. 9 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, and/or 6G. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted.” Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

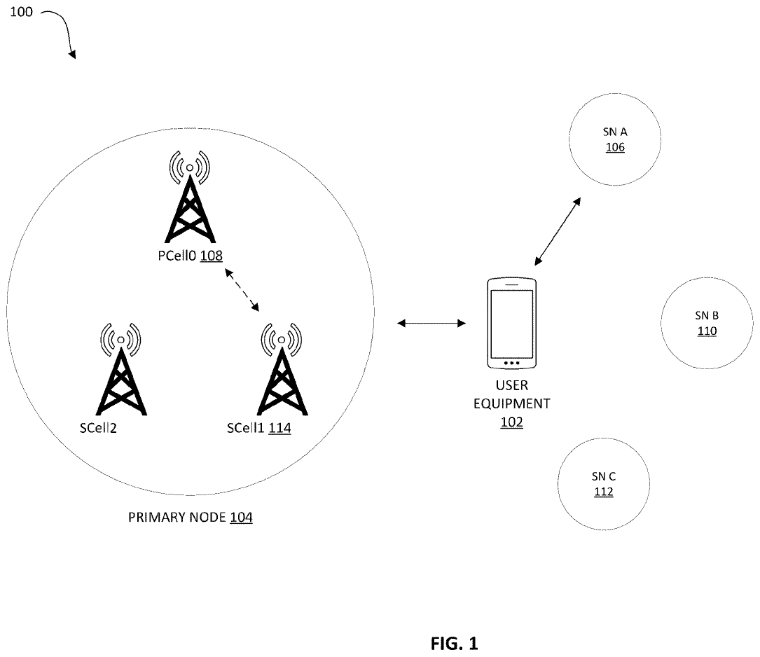

FIG. 1 is an illustration 100 for an intra-primary node (PN) change, according to one or more embodiments. As illustrated a user equipment (UE) 102 is in dual connectivity mode with a PN 104 and a secondary node (e.g., SN A) 106. The UE 102 can be in a connected state with a primary cell of (PCell0) 108 of the PN 108 and a cell of SN A 106. The dual connectivity mode enables the UE to use resources of both the PN 104 and SN A 106. The PN 104 can provide support for user plane and control plane traffic, while SN A 106 can provide additional capacity, if needed.

There are various schemes to support cell change/mobility for a UE in a connected state (e.g., legacy handover (HO), conditional HO) from one serving cell to another serving cell. However, these schemes focus on a single cell change (CG) procedure.

A PN-initiated primary serving cell (PSCell) addition (CPA) has been recently introduced. In CPA, a network can configure a set of secondary nodes for addition with the UE 102. These secondary nodes can include SN A 106, SN B 110, and SN C 112, among other SNs. The network can further configure the UE 102 with conditions (e.g., radio parameters) for the UE 102 to evaluate against to determine which SNs are suitable for addition. The UE 102 can evaluate each SN of the set of SNs against the conditions provided by the network. The UE 102 can add each SN from the set of SNs that fulfills the conditions and release each non-conforming SN. The UE 102 can be in a connected state with one of the SNs (e.g., SN A 106), and remain configured with the candidate SNs (e.g., SN B 110 and SN C 112).

As described herein an intra-SN conditional PSCell change (CPC) supported, and an inter-SN CPC, and a PN CPS are supported. In general, a target secondary cell group (SCG) configuration can be determined by a target SN. If the PN is involved, then the PN can provide coordination for the configuration. The source SN can determine one or more change conditions for changing from one serving cell to another serving cell of the source SN, if the SN initiates the change. If the PN initiates the change, then the PN can determine one or more change conditions for changing from one serving cell to another serving cell of the source SN. Additionally, the PN can determine one or more change conditions if the change is from a source SN to a target SN.

Whether the SN determines one or more change conditions or the PN determines one or more change conditions, the UE evaluates the candidate SNs, and performs the SCG change procedure in the event that a candidate SN fulfills one or more conditions. Once the SCG change procedure has been completed, the UE release the other candidate SNs.

Various SN addition/change schemes can include the following general steps. The network can provide the UE 102 with configuration information for each of the SNs (e.g., SN A 106, SN B 110, and SN C 112). The UE 102 can use the configuration information to establish a dual connectivity with the PN 104 and one of the SNs. As illustrated, the UE 102 is in dual connectivity mode with the PN 104 and SN A 106. If, however, one or more of the above-referenced change conditions occur, the UE 102 can establish a connection with a different SN while remaining connected to the PN 104. For example, in response to the fulfillment of one or more change conditions, the UE 102 can change a connection from SN A 106 to SN B 110 or SN C 112, such that the UE is in dual connectivity mode with the PN 104 and SN B 110 or SN C 112. The change condition can include, for example, the UE moving from one location to another location.

The configuration information can include security information for deriving security keys for each of the SNs. The UE 102 can use the security information to derive a PN security key (K_{gNB}). The security key enables the UE 102 to establish a secure connection with the PCell0 108. The security information can further associate a respective security key counter (sk_counter) for each SN (e.g., SN A 106, SN B 110, and SN C 112) that fulfilled one or more conditions.

The UE 102 can use the K_{gNB} and a respective sk_counter to derive an SN security key (K_{SN}) for each SN. The K_{SN} can be considered the SN equivalent of the K_{gNB}. The K_{SN} can be used to further derive a respective cipher key (CK) and an integrity key (IK) to establish a secure bearer connection (e.g., data radio bearer DRB, signaling radio bearer (SRB), such as SRB3), which can terminate at an SN packet data convergence protocol (PDCP). After the UE 102 applies the sk_counter to generate the security keys for each SN, the UE 102 can release the sk_counter configuration. Each time that there is an SN change, the PN 104 can use a respective sk_counter associated with a target SN for establishing a secure bearer connection with the target SN.

The PN 104 also derives a K_{SN} for each SN that fulfills one or more conditions for dual connectivity. The PN 104 provides a respective K_{SN} to each SN that fulfills one or more conditions for dual connectivity. Each SN can use its K_{SN} to derive a CK and an IK for a secure bearer connection with the UE 102. This procedure can be repeated each time that the UE 102 adds an SN or changes from one SN to another SN.

Each SCG will be configured with a separate sk_counter and logic for incrementing the sk_counter without radio resource control configuration. It should be appreciated that there are various methods for incrementing the sk_counter.

The current methods for CPA and CPC rely on the PN 104 not undergoing an intra-PN change or an inter-PN change. For example, the PN 104 configures the UE 102 and the SNs with the sk_counters and incrementation logic. If, however, the PN changes (e.g., intra-PN change or inter-PN change), there needs to be a reconfiguration of the SNs (e.g., SN A 106, SN B 110, and SN C 112) under the current methods.

In an example, upon a CG selective activation, the CPC/CPA configurations of the UE may be released after a PCell change, at least for inter-PN change (by explicit indication from the network. RAN2-212 is set for further study in the case of intra-PN change. It can be observed that a change of a serving cell from a PCell to an SCell (CA swap) in a node is still considered a HO in RAN2. The process is still performed with the assistance of RRC messaging. If the UE is in dual connectivity at the time of the HO message for performing the CA swap, and the network wants the UE to remain in dual connectivity mode, the PN is to associate the sk_counter with the SN.

A change of a serving cell from a PCell to an SCell calls for a change to the security key (SK_{gNB}) because the UE uses the PCell security key and the sk_counter to derive the SK_{gNB}. However, as the base station can use RRC messaging for configuring a node for an inter-PN change and an intra-PN change, configuring the PCell security key should present no issues.

One issue is that if a UE is in dual connectivity mode with a primary node, configured with candidate SNs (e.g., SN A 106, SN B 110, and SN C 112) and the PN changes (e.g., inter-PN change or intra-PN change), can the UE continue to be configured with the SNs using the original configuration information. Furthermore, can the UE continue to be configured with the SNs without a reconfiguration of the SNs (e.g., revaluation the one or more conditions for addition, such as associated trigger evaluation and evaluation of execution conditions).

It should be noted that there is no requirement that the candidate SNs are the same SNs during the initial configuration and when the PN changes. However, in the instance of an intra-PN change or in a situation in which the SNs do remain the same, it is useful to enable the UE to continue with the same configured SNs without having to reconfigure the SNs.

Referring to FIG. 1, the UE can be in a dual connectivity mode with the PN 104 and SN A 106. The UE 102 can further be configured with candidate secondary nodes SN B 110 and SN C 112. It should be appreciated that the even if the UE 102 is initially in a dual connectivity state with a PN and an SN, the UE can switch the initial SN to another SN. For example, presumably, time has passed since the UE 102 was configured with the SNs. During this time, the UE 102 can CPC from being in a connected state with the SN A 106 to a candidate SN (e.g., SN B 110, SN C 112). The UE 102 can engage in multiple CPCs and may return to a connected state with SN A 106 or be in a connected state with SN B or SN C. During this time, the sk_counter value for a candidate SN has been incremented based on an incrementation logic. For example, each time that the UE 102 enters a connected state with an SN (e.g., SN B 110), the sk_counter associated with the SN is incremented.

In some instances, the PN 104 can undergo an intra-PN change wherein the serving cell of the UE 102 changes from PCell0 108 to SCell1 114. This intra-PN change can be the result of a change in one or more radio condition. Furthermore, in the case of an intra-PN change, the PN security key (K_{gNB}) can remain the same. In the embodiments described herein, the UE 102 can be expected to keep the current SN (e.g., SN A 106) configuration and candidate SN (SN B 110 and SN C 112) configurations without a reconfiguration (e.g., revaluation the one or more conditions for addition, such as associated trigger evaluation and evaluation of execution conditions). In some instances, the network can configure the UE to continue with the SNs without reconfigurations of the SN and the candidate SNs.

As indicated above, the UE and the SNs use PN security key (K_{gNB}) and an sk_counter to derive the K_{SN}, which is further used to derive the CK and the IK for the secure bearer connection that which can terminate at the PDCP. Each time that an SN derives new security keys, the sk_counter can be incremented based on a logic and a new K_{SN} can be generated based on the new sk_counter value.

The UE 102 can perform one or more actions in relation to continuing with the current SN and candidate SN without reconfiguration. A first option can be that the UE 102 keeps the current sk_counter contexts for each of the SNs, (e.g., SN A 106, SN B 110, and SN C 112). The sk_counter contexts for each SN can include various information, such as an incrementation logic, a number of increments from when the initial S_{KN} was derived, and a current sk_counter value.

A second option can be for the UE 102 autonomously to reset each candidate SN's associated sk_counter value to an initial value that was provided to the UE 102 at the time the UE 102 was configured with the candidate SN.

A third option can be for the network to use RRC messaging to configure the UE 102 to explicitly do one of the following: maintain the sk_counter context for the SN and the candidate SNs, reset the sk_counter for the candidate SNs to the value that was provided to the UE 102 at the time the UE 102 was configured with the candidate SNs, or reset the sk_counter value to a designated value that was provided to the UE 102 at the time the UE was configured with the SNs. The designated value can be repeatedly used by the UE 102 each time an intra-PN change occurs. The RRC message can be the same RRC message used to trigger the intra-PN change.

Additionally, in the instance that the PN 104 undergoes an intra-PN change to change the serving cell of the UE 102 changes from PCell0 108 to SCell1 114, the PN 104 can perform actions related to the sk_counter. If the UE 102 does not reset that sk_counter context, the PN 104 can optionally transmit a message to the SNs indicating that intra-PN change. The message can further provide an indication for the SNs to maintain their sk_counter context.

In the event that the UE 102 does reset the sk_counter context, either autonomously or based on a configuration by the PN 104, the PN can transmit a message to the SNs to reset their respective sk_counter to a designated value. In this instance, the SNs can be pre-configured with the designated value. Alternatively, the PN 104 can transmit a message to the SNs providing respective designated values for each SN. In this alternative, the SNs do not have to be pre-configured with a designated value.

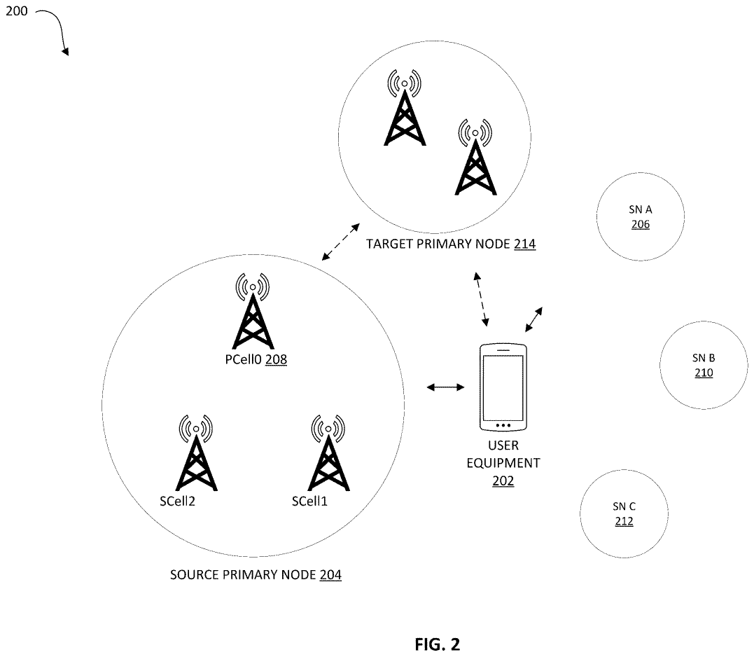

FIG. 2 is an illustration of an inter-PN change, according to one or more embodiments. As illustrated, a UE 202 is in dual connectivity mode with a source PN 204 and an SN (e.g., SN A) 206. The UE 202 can be in a connected state with a primary cell of (PCell0) 208 of the source PN 204 and a cell of the SN A 206. The UE 202 can further be configured with candidate SNs SN B 210 and SN C 212. The source PN 204 can undergo an inter-PN change, in which the PN changes from the source PN 204 to a target primary node.

As the PN has changed from the source PN 204 to the target PN 214, the PN security key (K_{gNB}) can change from a source PN key (Ks_{gNB}) to a target PN key (K_{TgNB}).

Similar to the above, the UE 202 can be expected to keep the current SN (e.g., SN A 106) configuration and candidate SN (SN B 110 and SN C 112) configurations. In some instances, the network can configure the UE 202 to keep the configurations of the SN and the candidate SNs.

Again, the UE 202 can perform one or more actions in relation to keeping the current SN configuration and candidate SN configurations. A first option can be that the UE 202 keeps the current sk_counter contexts for each of the SNs, (e.g., SN A 206, SN B 210, and SN C 212).

A second option can be for the UE 202 to autonomously reset a respective sk_counter value of each candidate SN to an initial value that was provided to the UE 102 at the time the UE 202 was configured with the candidate SNs.

A third option can be for the network to use RRC messaging to configure the UE 102 to explicitly do one of the following: maintain the sk_counter context for the SN and the candidate SNs, reset the sk_counter for the candidate SNs to the value that was provided to the UE 202 at the time the UE 202 was configured with the candidate SNs, or reset the sk_counter value to a designated value that was provided to the UE 202 at the time the UE was configured with the SNs. The designated value can be repeatedly used by the UE 202 each time an intra-PN change occurs. The RRC message can be the same RRC message used to trigger the intra-PN change.

The PN 204 can perform actions to enable the UE 202 to keep the current SN configuration and candidate SN configurations. In the instance that the UE 202 does not reset that sk_counter context, the source PN 204 can transmit a message to the SNs indicating that the inter-PN change has occurred from the source PN 204 to the target PN 214. The message can further include an indication for each SN to transmit the current sk_counter context to the source PN 204.

In response, each SN can transmit the current sk_counter context to the source PN 204. The source PN 204 can transmit each SNs current sk_counter context, including the current sk_counter value and increment logic, to the target PN 214.

In the instance that the UE 202 resets the sk_counter context, either autonomously or based on a source PN configuration, the source PN 204 can transmit a message to the SNs indicating that the inter-PN change has occurred from the source PN 204 to the target PN 214. The message can further include an indication for each SN to transmit the current sk_counter context to the source PN 204.

In response, each SN can transmit the current sk_counter context to the source PN 204. The source PN 204 can transmit each SNs initial sk_counter context, when the UE 202 was configured with the SNs. The initial sk_counter context can include the initial sk_counter value and increment logic, to the target PN 214.

The following example is provided using FIG. 1. As indicated above, the UE 1-2 is configured with SN A 106 and candidate SNs SN B 110 and SN C 112. The PN 104 has configured each SN with a respective sk_counter and a respective logic for incrementing the sk_counter. The UE 102 is in dual connectivity mode with the PN 104 and SN A 106.

The UE can perform a CPC procedure to change being in a connected state with SN A 106 to be in a connected state with SN B 110, without any additional RRC configuration messaging from the PN 104. The UE 102 can use the PN security key (K_{gNB}) and the sk_counter associated with SN B to derive an SN security key (K_{SN}). In some instances, the UE 102 can increment the sk_counter based on the logic and use the incremented sk_counter to generate the K_{SN}. In other instances, the UE 102 can increment the sk_counter after the sk_counter is used to generate the K_{SN}. The UE 102 can further use the K_{SN} to further derive a CK and an IK to establish a secure bearer connection (e.g., data radio bearer DRB, signaling radio bearer (SRB), such as SRB3), which can terminate at an SN packet data convergence protocol (PDCP). The PN 104 can derive a K_{SN} for SN A 106. SN A can use its K_{SN} to derive a CK and an IK for a secure bearer connection with the UE 102. The UE 102 changes from being in a dual connectivity mode with the PN 104 and the SN A 106 to being in a dual connectivity mode with the PN 104 and SN B 110.

A similar procedure can be performed for the UE 102 to change from being in a dual connectivity mode with the PN 104 and SN B 110 to being in a dual connectivity mode with the PN 104 and SN C 112. The UE can switch between SNs multiple times and the sk_counter values can be incremented in each instance. For example, the sk_counter associated with SN A 106 can be incremented five times, the sk_counter associated with SN B 110 can be incremented twice, and the sk_counter associated with SN C 112 can be incremented four times.

The UE 102 can receive an RRC message from the PN 104 that includes a new PN security key (K_{gNB}). The RRC message does not include any changes to the SN configuration, including the sk_counter context. Based on the RRC message, the UE 102 can switch from being in a dual connectivity with an SN and the PN 104 with PCell0 108 as the serving cell to being in dual connectivity mode with an SN and the PN 104 with SCell1 114 as the serving cell.

Based on the intra-PN change, the SNs need to be provided new SK-gNB values and a respective sk_counter content. It should be appreciated that neither the UE 102 nor the SNs transmit the PN 104 sk_counter incrementations (e.g., SN A 106 can be incremented five times, the sk_counter associated with SN B 110 can be incremented twice, and the sk_counter associated with SN C 112 can be incremented four times) to the PN 104.

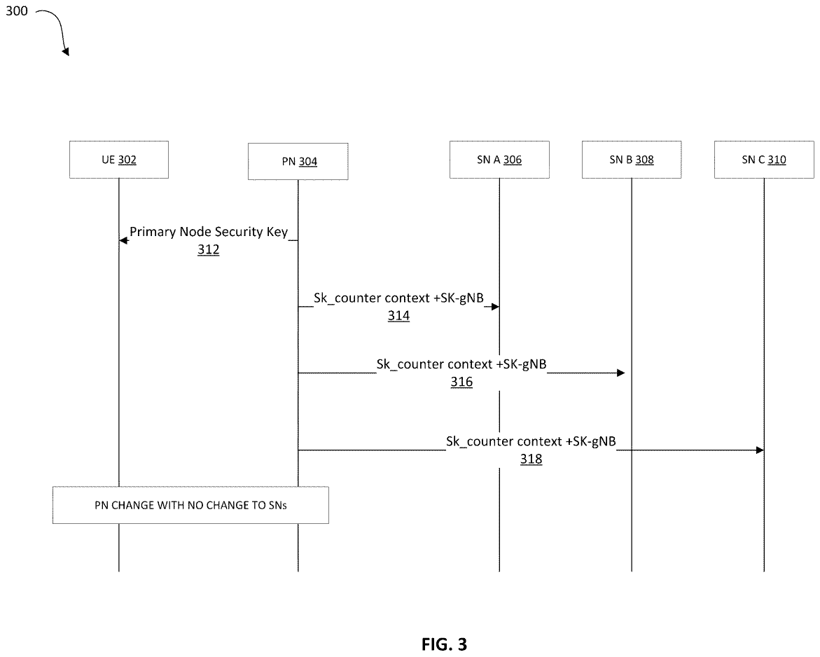

FIG. 3 is a signaling diagram 300 for an intra-PN change, according to one or more embodiments. As illustrated, a UE 302 can be inoperable communication with a PN 304, SN A 306, SN B 308, and SN C 310. The UE 302 can be in dual connectivity mode with the PN 304 and SN A 306. The UE 302 can further be configured with candidate SNs, SN B 308 and SN C 310, as described above. The UE 302 can switch from using one cell of the PN 304 as the serving cell to another cell of the PN as the serving cell.

At 312, the PN 304 can transmit a new K_{gNB} to the UE 302. The UE 302 can use the new K_{gNB} and the sk_counter to derive a K_{SN}. The K_{SN} can be used to further derive a CK and an IK to establish a secure bearer connection, which can terminate at a PDCP.

The PN 304 also derives a SK-gNB for each SN. At 314, 316, and 318 the PN 304 can provide a respective SK-gNB and sk_counter context to each of SN A 306, SN B 308, and SN C 310. Each SN can use their SK-gNB and sk_counter to derive a CK and an IK for a secure bearer connection with the UE 302.

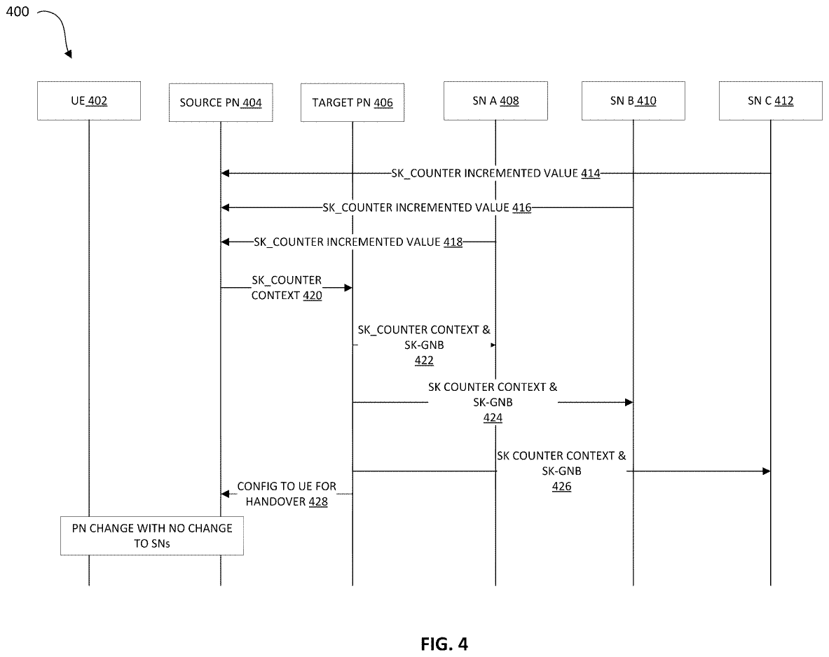

In the case of an inter-PN change, the SNs need to be provided to the PN 104 with sk_counter runtime context. FIG. 4 is a signaling diagram 400 for an inter-PN change, according to one or more embodiments. As illustrated, a UE 402 can be inoperable communication with a source PN 404, a target PN 406, SN A 408, SN B 410, and SN C 412. The UE 402 can be in dual connectivity mode with the source PN 404 and SN A 408. The UE 402 can further be configured with candidate SNs, SN B 410 and SN C 412 as described above. The UE 402 can switch from using the source PN 404 to provide the serving cell to the target PN 406 to provide the serving cell.

At 414, SN C 412 can provide the source PN 404 with an sk_counter incremented value. At 416, SN B 410 can provide the source PN 404 with an sk_counter incremented value. At 418, SN A 408 can provide the source PN 404 with an sk_counter incremented value.

At 420, the source PN 404 can provide the target PN 406 with the SK-counter context, including the respective sk_counter incremented values from the SNs received in steps 414, 416, and 418.

At 422, the target PN 506 can transmit the sk_counter context received from the source PN 404 and the SK-GNB to SN A 408. At 424, the target PN 506 can transmit the sk_counter context received from the source PN 404 and the SK-GNB to SN B 410. At 426, the target PN 506 can transmit the sk_counter context received from the source PN 404 and the SK-GNB to SN C 412. The SNs can use the information to derive security keys for a secure bearer connection with the UE 402. At 428, the target PN 406 can transmit UE configuration information to the source PN 404.

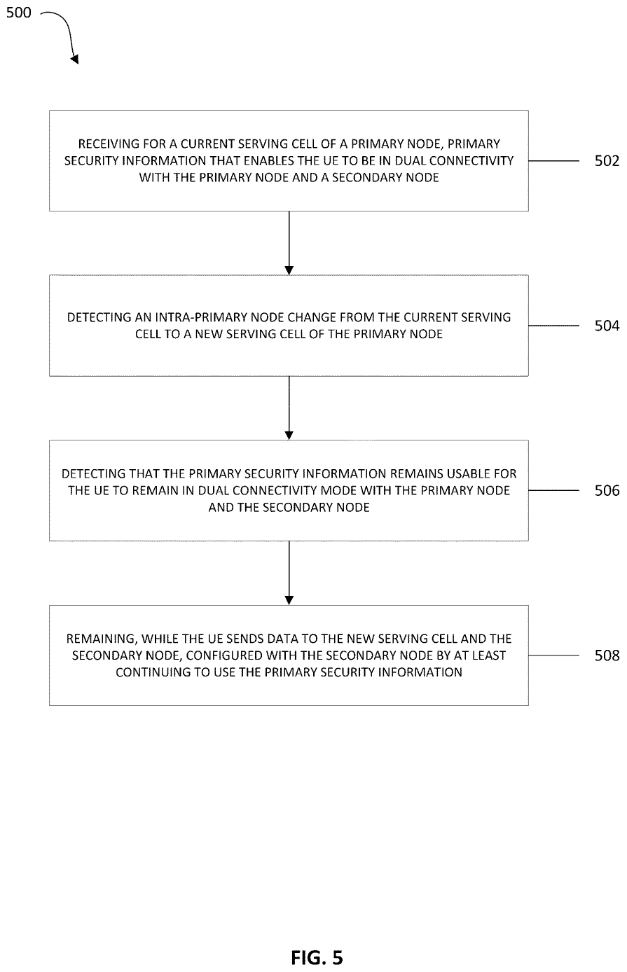

FIG. 5 is a process flow 500 for an intra-PN change, according to one or more embodiments. At 502, a method can include a UE receiving, from a current serving cell of a primary node, primary security information that enables the UE to be in dual connectivity mode with the PN and an SN. The primary security information can be a respective security key counter context associated with the SN.

At 504, the method can include the UE detecting an intra-PN change from the current serving cell to a new serving cell of the PN. The UE can further detect that a PN security key has not changed.

At 506, the method can include the UE detecting that the primary security information remains usable for the UE to remain in the dual connectivity mode with the PN and the SN. For example, the UE can base a subsequent action based on a current sk_counter context.

The subsequent action can include maintaining a current respective security key counter content associated with the SN and a candidate secondary node. The subsequent action can further include resetting a respective security key counter value associated with SN and the candidate SN to a respective security key counter value at a time of receiving the configuration. The subsequent action can further include receiving a radio resource control (RRC) message from a base station, and based on the RRC message: maintaining a respective current security key context associated with the SN and the candidate secondary node; resetting a respective security key counter value associated with the SN and the candidate SN to respective security key counter value at a time of receiving the configuration, or resetting a respective security key value associated with the SN and the candidate SN to a separate value provided at the time of configuration.

At 508, the method can include the UE remaining, while the UE sends data to the new serving cell and the SN, configured with the SN by at least continuing to use the primary security information.

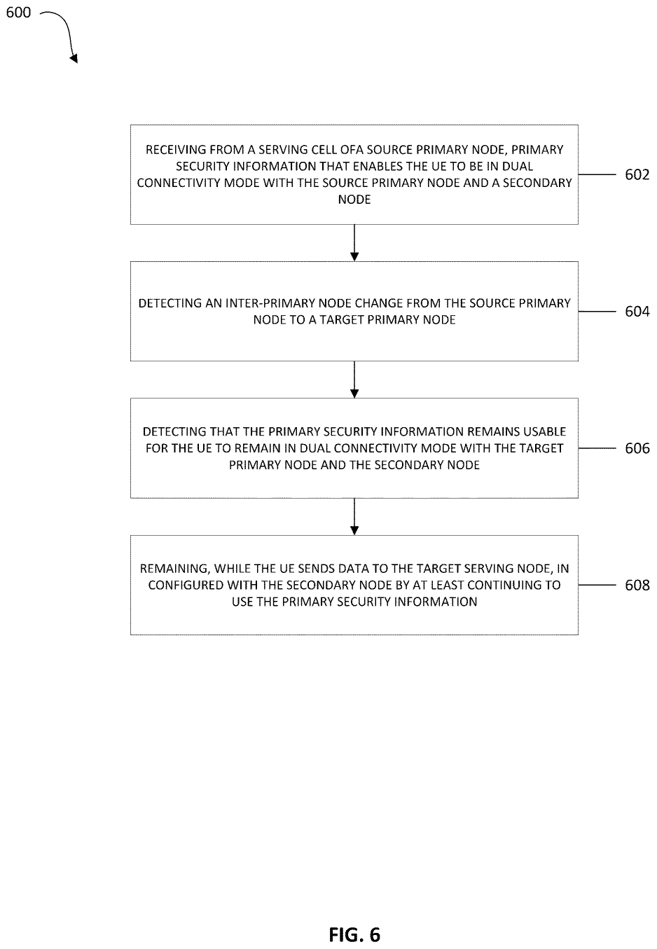

FIG. 6 is a process flow 600 for an inter-PN change, according to one or more embodiments. At 602, the method can include a UE receiving, from a serving cell of a source primary node, primary security information that enables the UE to be in dual connectivity mode with the source PN and the SN.

At 604, the method can include the UE detecting an inter-PN change from the source PN to a target primary node. The UE can further detect that a PN security key has changed.

At 606, the method can include the UE detecting that the primary security information remains usable for the UE to remain in the dual connectivity mode with the target PN and the secondary node. For example, the UE can base a subsequent action based on a current sk_counter context.

The subsequent action can include maintaining a current respective security key counter content associated with the SN and a candidate secondary node. The subsequent action can further include resetting a respective security key counter value associated with SN and the candidate SN to a respective security key counter value at a time of receiving the configuration. The subsequent action can further include receiving a radio resource control (RRC) message from a base station, and based on the RRC message: maintaining a respective current security key context associated with the SN and the candidate secondary node; resetting a respective security key counter value associated with the SN and the candidate SN to respective security key counter value at a time of receiving the configuration, or resetting a respective security key value associated with the SN and the candidate SN to a separate value provided at the time of configuration.

At 608, the method can include the UE remaining, while the UE sends data to the target serving node, configured with the SN by at least continuing to use the primary security information.

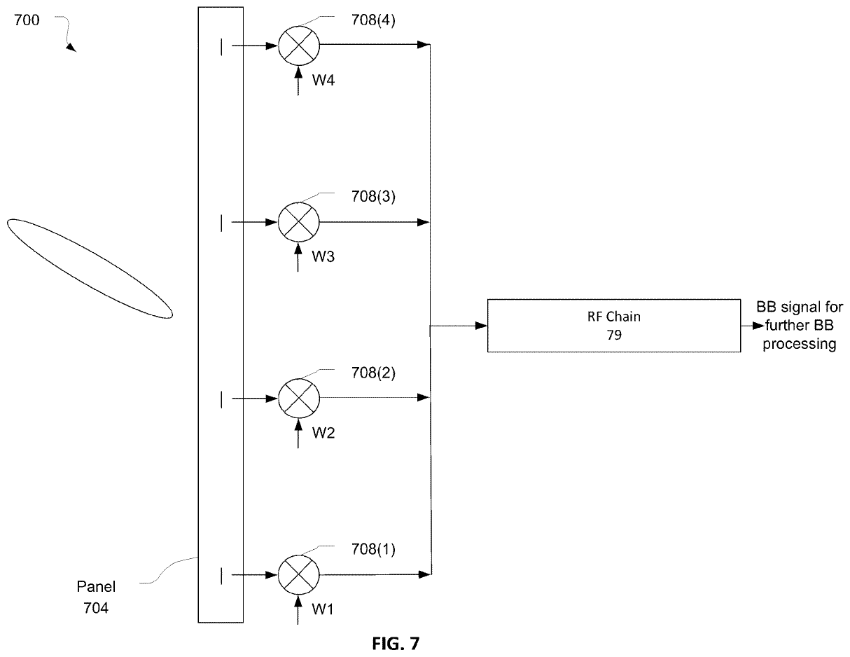

FIG. 7 illustrates receive components 700 of the UE 706, in accordance with some embodiments. The receive components 700 may include an antenna panel 704 that includes a number of antenna elements. The panel 704 is shown with four antenna elements, but other embodiments may include other numbers.

The antenna panel 704 may be coupled to analog beamforming (BF) components that include a number of phase shifters 708(1)-708(4). The phase shifters 708(1)-708(4) may be coupled with a radio-frequency (RF) chain 712. The RF chain 712 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 708(1)-708(4) to provide a receive beam at the antenna panel 704. These BF weights may be determined based on the channel-based beamforming.

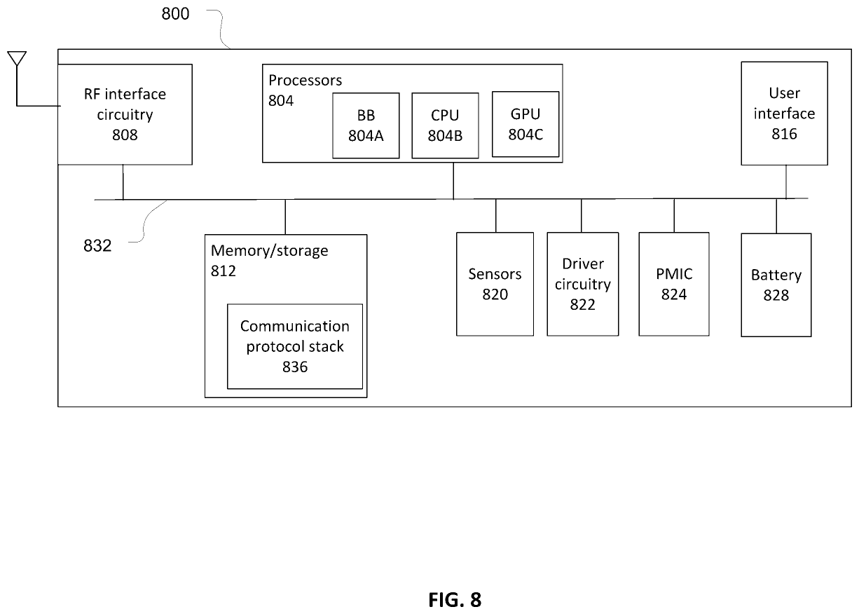

FIG. 8 illustrates a UE 800, in accordance with some embodiments. The UE 800 may be similar to and substantially interchangeable with UE 706 of FIG. 7.

Similar to that described above with respect to UE 800, the UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 800 may include processors 804, RF interface circuitry 808, memory/storage 812, user interface 816, sensors 820, driver circuitry 822, power management integrated circuit (PMIC) 824, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 804A may also access group information 824 from memory/storage 812 to determine search space groups in which a number of repetitions of a PDCCH may be transmitted.

The memory/storage 812 may include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 824 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 824.

In various embodiments, the RF interface circuitry 808 may be configured to transmit/receive signals in a manner compatible with NR access technologies.

The antenna 824 may include a number of antenna elements that each convert electrical signals into radio waves to travel through the air and to convert received radio waves into electrical signals. The antenna elements may be arranged into one or more antenna panels. The antenna 824 may have antenna panels that are omnidirectional, directional, or a combination thereof to enable beamforming and multiple input, multiple output communications. The antenna 824 may include microstrip antennas, printed antennas fabricated on the surface of one or more printed circuit boards, patch antennas, phased array antennas, etc. The antenna 824 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations such as channel quality feedback, handover, etc. The UE 800 goes into a very low power state and it performs paging where again it periodically wakes up to listen to the network and then powers down again. The UE 800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

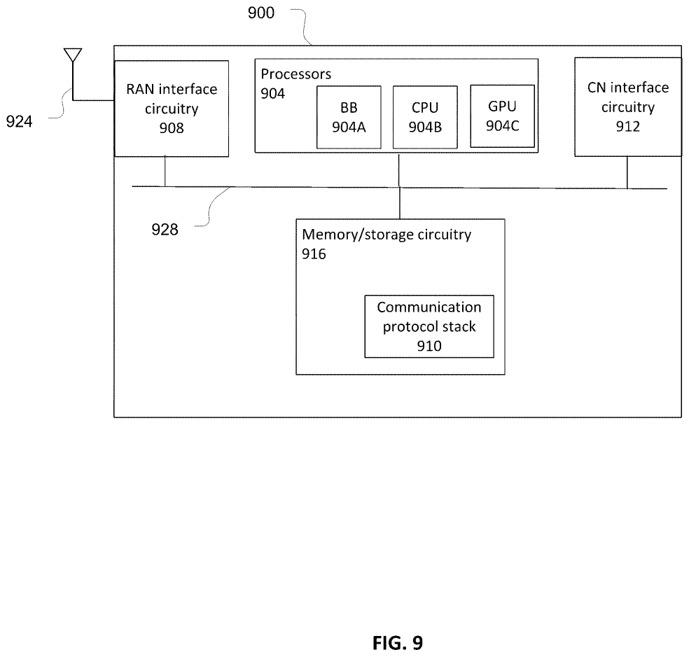

FIG. 9 illustrates a gNB 900, in accordance with some embodiments. The gNB node 900 may be similar to and substantially interchangeable with the base stations 94, 96 of FIG. 1.

The gNB 900 may include processors 904, RF interface circuitry 908, core network (CN) interface circuitry 912, and memory/storage circuitry 916.

The components of the gNB 900 may be coupled with various other components over one or more interconnects 928.

The processors 904, RF interface circuitry 908, memory/storage circuitry 916 (including communication protocol stack 910), antenna 924, and interconnects 928 may be similar to like-named elements shown and described with respect to FIG. 7.

The CN interface circuitry 912 may provide connectivity to a core network, for example, a 4th Generation Core network (5GC) using a 4GC-compatible network interface protocol such as carrier Ethernet protocols, or some other suitable protocol. Network connectivity may be provided to/from the gNB 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further example embodiments are provided.

Example 1 includes a method performed by a UE, the method comprising: receiving, from a current serving cell of a PN, primary security information that enables the UE to be in dual connectivity mode with the PN and a SN; detecting an intra-PN change from the current serving cell to a new serving cell of the PN; detecting that the primary security information remains usable for the UE to remain in the dual connectivity mode with the PN the SN; and remaining, while the UE sends data to the new serving cell and the SN, connected with the SN by at least continuing to use the primary security information.

Example 2 includes the method of example 1, wherein the primary security information is a security key counter context associated with the SN.

Example 3 includes the method of example 1 or 2, wherein detecting an intra-PN change from the current serving cell to a new serving cell of the PN comprises detecting that a PN security key has not changed.

Example 4 includes the method of any of examples 1-3, wherein the UE is configured with the SN and a candidate SN, and wherein the method further comprises maintaining configurations for the SN and the candidate SN.

Example 5 includes the method of example 4, wherein the method further comprises maintaining a current security key counter content associated with the SN and the candidate SN.

Example 6 includes the method of any of examples 1-5, wherein the method further comprises resetting a security key counter value associated with the SN and a candidate SN to a respective security key counter value at a time of receiving a first configuration information associated with the SN and a second configuration information associated with candidate SN.

Example 7 includes the method of any of examples 1-6, wherein the method further comprises: receiving an RRC message from a base station; and based on the RRC message: maintaining a current security key context associated with the SN and a candidate SN; and resetting a respective security key counter value associated with the SN and the candidate SN to respective security key counter value at a time of receiving the configuration, or resetting a respective security key value associated with the SN and the candidate SN to a separate value provided at the time of configuration.

Example 8 includes one or more computer-readable media having stored thereon a sequence of instructions which, when executed, causes a processor to perform operations including a method described in or related to examples 1-7.

Example 9 includes a device comprising memory; processing circuitry, coupled with the memory, to perform one or more elements of a method described in or related to examples 1-7.

Example 10 includes a method, performed by a PN, the method comprising: determining an intra-PN change of a UE switching from a first serving cell of the PN to a second serving cell of the PN, a UE in dual connectivity mode with the PN and an SN; determining that a primary cell security key associated with the PN remains unchanged; and transmitting a first indication to the SN that the UE switched from the first serving cell of the PN to the second serving cell of the PN.

Example 11 includes the method of example 10, wherein the method further comprises: detecting that the UE has reset a security key counter context associated with the SN; and transmitting a second indication to the SN to reset a security counter value to a pre-configured value, wherein the secondary is pre-configured with the value prior to second indication.

Example 12 includes the method of example 10, wherein the method further comprises: detecting that the UE has reset a security key counter context associated with the SN; and transmitting a second indication to the SN to reset the security counter value to a value, wherein the value is included in the second indication.

Example 13 includes one or more computer-readable media having stored thereon a sequence of instructions which, when executed, causes a processor to perform operations including a method described in or related to examples 10-12.

Example 14 includes a device comprising memory; processing circuitry, coupled with the memory, to perform one or more elements of a method described in or related to examples 10-12.

Example 15 includes a UE, comprising: memory; processing circuitry, coupled with the memory, to: receive, from a serving cell of a source PN, primary security information that enables the UE to be in dual connectivity mode with the source PN and a SN; detect an inter-PN change from the source PN to a target PN; detect that the primary security information remains usable for the UE to remain in the dual connectivity mode with the target PN and the SN; and remain, while the UE sends data to the target serving node, configured with the SN by at least continuing to use the primary security information.

Example 16 includes the UE example 15, wherein the processing circuitry, coupled with the memory to detect that a security key associated with the target PN.

Example 17 includes the UE example 15, wherein the processing circuitry, coupled with the memory, further to maintain respective configurations for the SN.

Example 18 includes the UE example 15, wherein the processing circuitry, coupled with the memory, further to maintain a current respective security key counter context associated with the SN.

Example 19 includes the UE example 15, wherein the processing circuitry, coupled with the memory, further to autonomously reset a security key counter value associated with the SN to security key counter value at a time of receiving the configuration.

Example 20 includes the UE example 15, wherein the processing circuitry, coupled with the memory, further receiving an RRC message from a base station, and based on the RRC message: maintain a respective current security key context associated with the SN and a candidate SN; reset a respective security key counter value associated with the SN and the candidate SN to respective security key counter value at a time of receiving the configuration, or reset a respective security key value associated with the SN and the candidate SN to a separate value provided at the time of configuration.

Example 21 includes one or more computer-readable media having stored thereon a sequence of instructions which, when executed, causes a processor to perform operations including a method described in or related to examples 10-20.

Example 22 includes a method performed by a device comprising memory; processing circuitry, coupled with the memory, to perform one or more elements of the steps described in or related to examples 10-20.

Example 23 includes one or more non-transitory computer-readable media including stored thereon instructions that, when executed by one or more processors, cause a source primary node (PN) to: detect an inter-PN change from the source PN to a target PN, a UE in dual connectivity mode with the source PN and a SN; detecting whether the UE has reset a security key counter associated with the SN; and transmit a first indication to the SN of the inter-PN change from the source PN to the target PN based on the determination.

Example 24 includes the one or more non-transitory computer-readable media of example 23, wherein the instructions that, when executed by the one or more processors, further cause the source PN to: detect that the UE has maintained a respective current security key counter context associated with the SN and a candidate SN; transmit a second indication, to the candidate SN, of the inter-PN change from the source PN to the target PN; and receive from SN and the candidate SN a respective current security key context.

Example 25 includes the one or more non-transitory computer-readable media of example 23, wherein the instructions that, when executed by the one or more processors, further cause the source PN to transmit a first identity of the SN and a second identity of a candidate SN to the target PN.

Example 26 includes the one or more non-transitory computer-readable media of example 23 or 24, wherein the instructions that, when executed by the one or more processors, further cause the source PN to transmit an initial security key context and an increment logic to the target PN.

Example 27 includes a device comprising memory; processing circuitry, coupled with the memory, to perform one or more elements of a method described in or related to examples 23-26.

Example 28 includes a method performed by a device comprising memory; processing circuitry, coupled with the memory, to perform one or more elements of the steps described in or related to examples 23-26.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method, comprising:
receiving, from a current serving cell of a primary node (PN), primary security information that enables a user equipment (UE) to be in dual connectivity mode with the PN and a secondary node (SN);
detecting an intra-PN change from the current serving cell to a new serving cell of the PN;
detecting that the primary security information remains usable for the UE to remain in the dual connectivity mode with the PN the SN; and
remaining connected with the SN by at least continuing to use the primary security information while data is sent to the new serving cell and the SN.

22. The method of claim 21, wherein the primary security information is a security key counter context associated with the SN.

23. The method of claim 21, wherein detecting an intra-PN change from the current serving cell to a new serving cell of the PN comprises detecting that a PN security key has not changed.

24. The method of claim 21, wherein the UE is configured with the SN and a candidate SN, and wherein the method further comprises maintaining configurations for the SN and the candidate SN.

25. The method of claim 24, wherein the method further comprises maintaining a current security key counter content associated with the SN and the candidate SN.

26. The method of claim 21, wherein the method further comprises resetting a security key counter value associated with the SN and a candidate SN to a respective security key counter value at a time of receiving a first configuration information associated with the SN and a second configuration information associated with candidate SN.

27. The method of claim 21, wherein the method further comprises:
receiving a radio resource control (RRC) message from a base station; and
based on the RRC message:
maintaining a current security key context associated with the SN and a candidate SN; and
resetting a respective security key counter value associated with the SN and the candidate SN to respective security key counter value at a time of configuration, or
resetting a respective security key value associated with the SN and the candidate SN to a separate value provided at the time of configuration.

28. A method, comprising:
determining a primary node (PN) change of a user equipment (UE) switching from a first serving cell to a second serving cell, wherein the UE is in dual connectivity mode with the PN and a secondary node (SN); and
outputting, for transmission, a first indication to the SN that the UE switched from the first serving cell to the second serving cell.

29. The method of claim 28, wherein the PN change is a intra-PN change of the UE switching from a first serving cell of the PN to a second serving cell of the PN, the first indication indicates the intra-PN change from the first serving cell of the PN to the second serving cell of the PN, and the method further comprises:
determining that a primary cell security key associated with the PN remains unchanged.

30. The method of claim 29, further comprising:
detecting that the UE has reset a security key counter context associated with the SN; and
outputting, for transmission, a second indication to the SN to reset a security counter value to a value, wherein the value is included in the second indication or the SN is pre-configured with the value prior to second indication.

31. The method of claim 28, wherein the PN change is a inter-PN change of the UE switching from a source PN including the first serving cell to a target PN including the second serving cell, and the method further comprises:
determining whether the UE has reset a security key associated with the SN, and wherein the first indication indicates the inter-PN change from the source PN to the target PN based on the determination.

32. The method of claim 11, further comprising:
detecting that the UE has maintained a respective current security key counter context associated with the SN and a candidate SN;
outputting, for transmission, a second indication of the inter-PN change from the source PN to the target PN to the candidate SN; and
receiving, from the SN and the candidate SN, a respective current security key context.

33. The method of claim 31, further comprising: outputting, for transmission, a first identity of the SN and a second identity of a candidate SN to the target PN.

34. The method of claim 31, further comprising: outputting, for transmission, an initial security key context and an increment logic to the target PN.

35. An apparatus, comprising:
processing circuitry to:
receive, from a serving cell of a source primary node (PN), primary security information that enables a user equipment (UE) to be in dual connectivity mode with the source PN and a secondary node (SN);
detect an inter-PN change from the source PN to a target PN;
detect that the primary security information remains usable for the UE to remain in the dual connectivity mode with the target PN and the SN; and
remain configured with the SN by at least continuing to use the primary security information while data is sent to the target serving node; and
interface circuitry, coupled to the processor circuitry, to enable communication.

36. The apparatus of claim 35, wherein the processing circuitry is further to detect that a security key is associated with the target PN.

37. The apparatus of claim 35, wherein the processing circuitry is further to maintain respective configurations for the SN.

38. The apparatus of claim 35, wherein the processing circuitry is further to maintain a current respective security key counter context associated with the SN.

39. The apparatus of claim 35, wherein the processing circuitry is further to autonomously reset a security key counter value associated with the SN to security key counter value at a time of receiving the configuration.

40. The apparatus of claim 35, wherein the processing circuitry is further to receive a radio resource control (RRC) message from a base station, and based on the RRC message:
maintain a respective current security key context associated with the SN and a candidate SN
reset a respective security key counter value associated with the SN and the candidate SN to respective security key counter value at a time of receiving the configuration, or
reset a respective security key value associated with the SN and the candidate SN to a separate value provided at the time of configuration.
